(19) United States
(12) Patent Application Publication
(10) Pub. No.: US 2024/0405890 A1
(43) Pub. Date: Dec. 5, 2024

(54) FIBER-OPTIC ACOUSTIC ANTENNA ARRAY AS AN ACOUSTIC COMMUNICATION SYSTEM

(71) Applicant: NEC Laboratories America, Inc., Princeton, NJ (US)

(72) Inventors: Wataru KOHNO, PRINCETON, NJ (US); Jian FANG, PRINCETON, NJ (US); Shuji MURAKAMI, MONMOUTH JUNCTION, NJ (US); Ting WANG, WEST WINDSOR, NJ (US)

(73) Assignee: NEC Laboratories America, Inc., Princeton, NJ (US)

(21) Appl. No.: 18/731,283

(22) Filed: Jun. 1, 2024

Related U.S. Application Data
(60) Provisional application No. 63/470,321, filed on Jun. 1, 2023.
(60) Provisional application No. 63/470,333, filed on Jun. 1, 2023.

(51) Int. Cl. H04B 11/00; G01H 9/00; H04B 13/02

(52) U.S. Cl. CPC H04B 11/00; G01H 9/004; H04B 13/02

(57) ABSTRACT

Disclosed are systems, methods, and structures employing a distributed fiber optic sensing (DFOS)/distributed acoustic sensing (DAS) system operating as an underwater wireless acoustic antenna in which an optical fiber sensor cable serves as a distributed acoustic antenna that receives multiple data from transmitters using an optical interrogator. Sensing channels, in the form of acoustic-antenna-array systems are located near transmitters taking advantage of the fact that these channels are automatically synchronized. The sensing channels may also be manually selected from software controlling the interrogator, and acoustic repeaters may be introduced as one data transmission mechanism. Acoustic tata transmission using an orthogonal frequency division multiplexed (OFDM) signal is demonstrated as a cure for data transmission using a DAS, such as multipath fading impacting bit error rate (BER) and limitations in acoustic transmission bandwidth.

### CROSS-REFERENCE TO RELATED APPLICATIONS

This application claims the benefit of U.S. Provisional Patent Application Ser. No. 63/470,321 filed Jun. 1, 2023, and U.S. Provisional Patent Application Ser. No. 63/70,333 filed Jun. 1, 2023, the entire contents of each is incorporated by reference as if set forth at length herein.

### FIELD OF THE INVENTION

This application relates generally to distributed fiber optic sensing (DFOS) systems, methods, structures, and related technologies. More particularly, it pertains to a fiber-optic acoustic antenna array used as an acoustic communication system that enables underwater wireless sensor networks.

### BACKGROUND OF THE INVENTION

Distributed fiber optic sensing (DFOS) systems, methods, and structures have found widespread utility in contemporary industry and society. The present invention and disclosure provide a novel extension of DFOS utility as a monitor for a vast and inaccessible marine environment utilizing distributed fiber optic sensing/distributed acoustic sensing (DFOS/DAS) not only as a sensing system but also as an acoustic antenna, enabling their use as signal receivers for underwater wireless sensor networks (UWSN) and infrastructures constructed therefrom.

### SUMMARY OF THE INVENTION

An advance in the art is made according to aspects of the present disclosure directed to systems, methods, and structures employing a distributed fiber optic sensing (DFOS)/distributed acoustic sensing (DAS) system operating as an underwater wireless acoustic antenna in which an optical fiber sensor cable serves as a distributed acoustic antenna that receives multiple data from transmitters using an optical interrogator.

Sensing channels, in the form of acoustic-antenna-array systems are located near transmitters taking advantage of the fact that these channels are automatically synchronized. The sensing channels may also be manually selected from software controlling the interrogator, and acoustic repeaters may be introduced as one data transmission mechanism.

Acoustic tata transmission using an orthogonal frequency division multiplexed (OFDM) signal is demonstrated as a cure for data transmission using a DAS, such as multipath fading impacting bit error rate (BER) and limitations in acoustic transmission bandwidth.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative distributed fiber optic sensor/distributed acoustic sensor (DFOS/DAS) configured as an underwater wireless sensor network (UWSN) according to aspects of the present disclosure.

FIG. 3 is a schematic flow diagram showing illustrative operational flow a DFOS/DAS UWSN according to aspects of the present disclosure.

FIG. 4 is a schematic flow diagram showing an illustrative embodiment of a DFOS/DAS UWSN according to aspects of the present disclosure.

FIG. 5 is a schematic block diagram showing illustrative hierarchical relationships according to aspects of the present disclosure.

FIG. 6 is a schematic block diagram showing an illustrative experimental arrangement of a DFOS/DAS antenna array showing experimental geometry and flow of data according to aspects of the present disclosure.

FIG. 7 is a set of plots showing normalized power spectrums of transmitted/received OFDM signals for preambles, where the maximum values are set at 0 dB, according to aspects of the present disclosure.

FIG. 8 is a plot showing bit error rate BER as a function of subcarrier frequency in which the highlighted points are subcarriers with finite BER according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

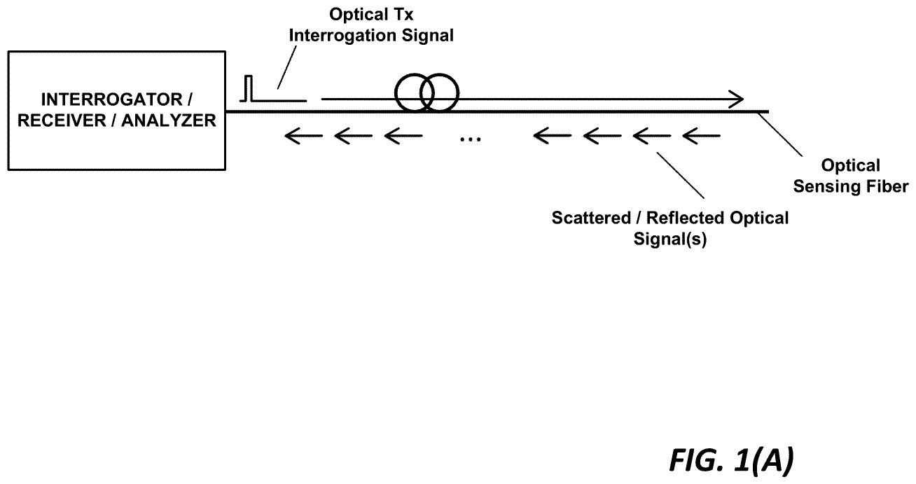

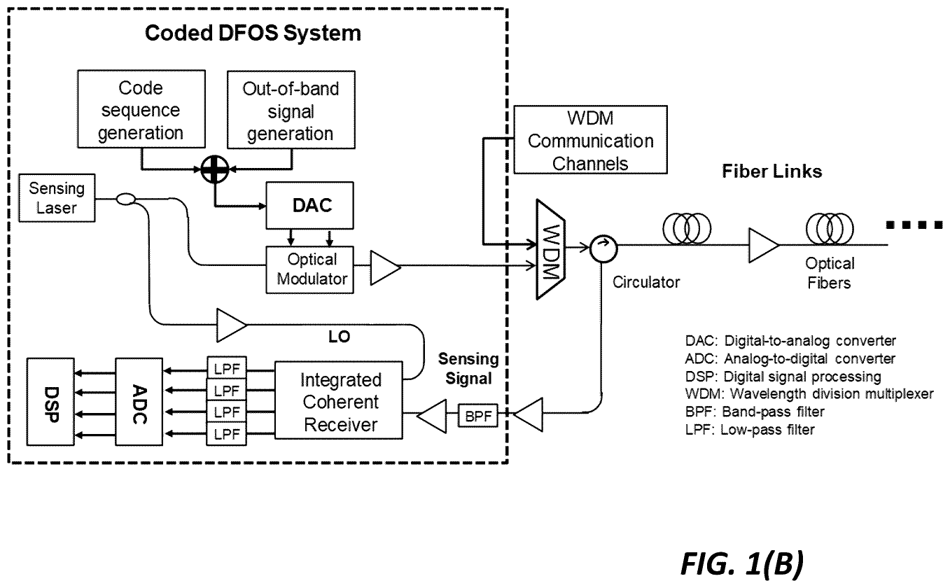

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DVS allows for continuous monitoring over long distances, but instead of measuring temperature, it measures vibrations and sounds along the fiber.

DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As the technology continues to develop, DAS/DVS is expected to become even more widely used in various fields where continuous and sensitive acoustic/vibration monitoring is crucial.

With the above in mind and given that so much of the Earth's surface is covered by water, it is essential to unravel the mysteries and resources of the ocean. However, this task poses significant challenges due to the vastness and inaccessibility of the marine environment.

To overcome these challenges, we have been exploring novel methods for transmitting data over long distances in water. Underwater wireless sensor network (UWSN) technology is a rapidly growing field of research that can contribute significantly to various sectors, such as offshore oil and gas extraction, military surveillance, mine detection, pollution monitoring, and natural disaster forecasting. Additionally, UWSNs have versatile applications, such as coral reef and marine habitat monitoring, and fish farming. These applications rely on multiple sensor nodes that can collect crucial parameters of underwater environments such as water temperature, pressure, salinity, and images.

On the transmission side, acoustic communication has emerged as the most practical method for transmitting this data, due in part to its efficient propagation underwater. Therefore, hydrophones, which convert acoustic energy to electrical energy, are indispensable devices as receivers in underwater acoustic applications. However, there are still some fundamental issues with acoustic communication systems that use hydrophones as acoustic antennas.

Retrieving acoustic data: Hydrophone systems alone cannot send information. To retrieve data for undersea exploration, hydrophones must be connected directly to a computer on a ship or to buoys that can transform received signals to radio waves. Thus, hydrophones should be connected to the device that decodes the information in some way.

Limited number and density: Since hydrophones are local point receivers, creating a dense network can be prohibitively costly.

Maintenance costs: When designing automated UWSNs, maintaining the system is crucial. However, with a hydrophone-based system, one can only detect which device is broken. There is generally no way of knowing why the receiver failed or where it is currently located.

Time synchronization: Precise localization of the transmitter requires accurate time synchronization between each hydrophone array.

The use of undersea telecommunications optical fiber with fiber-sensing is yet another way to explore undersea environments and the subject of this disclosure. Distributed acoustic sensing (DAS), which is one of the fiber-sensing systems noted above, can detect acoustic signals around an optical fiber by demodulating the phase change of the Rayleigh backscattered light linear to the small dynamic strain on an optical sensor fiber.

Recently, researchers have studied DAS for detecting acoustic waves in air and underwater and transforming an optical fiber into an array of microphones or hydrophones for moving-object-detection systems. One of the clear advantages is that the sensing data at all channels in an optical fiber can be retrieved by a single DAS on a land connected to the optical fiber. However, the fiber sensing systems are limited to collecting sensor information for target physical quantities such as acoustic signals, temperature, strain, etc., only from the vicinity of optical sensor fibers.

The invention of the present disclosure describes a solution for monitoring the vast and inaccessible marine environment by utilizing DAS not only as sensing systems but also as acoustic antennas, enabling them to serve as signal receivers for UWSN infrastructures.

As noted previously, Optical-fiber sensor cable serves as a distributed acoustic antenna that retrieves multiple data from transmitters using a single interrogator. Sensing channels, in the form of an acoustic-antenna-array systems, are placed near transmitters, taking advantage of the fact that these channels are automatically synchronized. These sensing channels can also be selected manually from software controlling an interrogator. Acoustic repeaters communicatively coupled to an optical sensor fiber can be introduced as one of the means of data transmission.

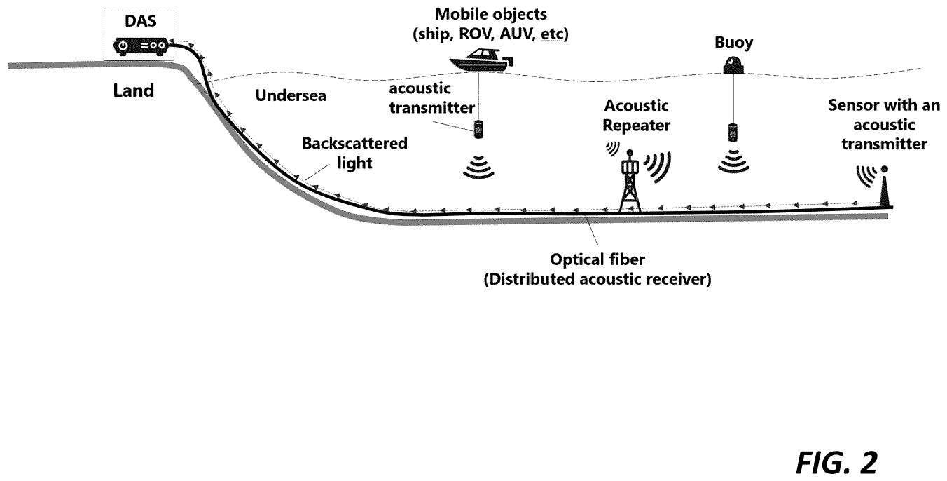

FIG. 2 is a schematic diagram showing illustrative distributed fiber optic sensor/distributed acoustic sensor (DFOS/DAS) configured as an underwater wireless sensor network (UWSN) according to aspects of the present disclosure.

As illustratively shown in that figure, a DFOS/DAS system is deployed in an undersea environment. The DFOS/DAS system includes a DAS interrogator and analysis system coupled to an optical sensor fiber (distributed acoustic receiver) that is illustratively deployed along a floor of an underwater environment.

The DAS that is connected to the undersea optical sensor cable is shown as located on land to collect phase change(s) of Rayleigh backscattered light that is produced during operation of the DAS interrogator and system. As may be readily appreciated by those skilled in the art, digital DAS data collected by the DAS originate from various sources such as undersea sensors, ships, Remote Operated Vehicles (ROVs), Autonomous Underwater Vehicles (AUVs), and buoys that encode as acoustic waves and mechanically transmit to the optical fiber via seawater. The optical fiber functions as a distributed acoustic receiver and serves as one of the infrastructures in the undersea acoustic communication network Acoustic repeaters can be added as additional acoustic paths towards the optical sensor fiber to extend the transmission range underwater.

As those skilled in the art will readily appreciate, one application of this invention is autonomous undersea exploration. Autonomous Underwater Vehicles (AUVs) equipped with sensors capable of measuring various physical quantities such as temperature, pressure, and salinity, can be deployed to navigate the undersea environment and transmit acoustic signals to fiber-optic cables. Additionally, static sensors can be placed on the ocean floor to transmit signals at specific frequencies. These signals can be received by Distributed Acoustic Sensing (DAS) systems which are able to track the locations of the sensors and gather information about the undersea environment from the sensor parameters. By addressing challenges such as those noted above, DAS systems with optical sensor fiber cables can serve as signal receivers for Underwater Sensor Networks (UWSNs), providing valuable insights into the undersea environment.

Retrieving acoustic data: DAS detects/analyzes acoustic signals using Rayleigh backscattered light, and acoustic signals from all channels are transmitted to, and accumulated and analyzed by the interrogator and analyzer. As a result, data retrieval can be performed on land by simply connecting the interrogator to the undersea optical sensor cable.

Limited number and density: DAS detects phase change(s) of Rayleigh backscattered light between any two arbitrary points (the distance is referred to as the “gauge length”) in an optical sensor fiber. When the gauge length is set to 10 m (typically at most 100 m), a 100 km optical fiber cable has 10,000 sensing channels. Thus, densely distributed receivers can be constructed with a single optical fiber sensor cable.

Maintenance costs: Some abnormal acoustic events, such as cable cuts due to ship anchors, can be monitored using DAS. When an abnormality is detected, one can determine the cable length/position where the event occurred based on the traveling time of the backscattered light. Since regular maintenance is done for the optical communication line, special care for DAS as a sensor is not needed.

Time synchronization: DAS is also referred to as phase sensitive OTDR (Optical Time Domain Reflectometer). Information about optical fiber sensor cable length from the interrogator is determined from the traveling time of the backscattered light. Thus, the measurement-time difference between two sensing channels with cable distance d is given by Δt=2d/c, where c is the speed of light in the fiber. Setting d=10 m, the acoustic-signal propagation distance in time is calculated as cₛΔt˜0.00015 m<<d (where speed of sound cₛ=1500 m/sec). Thus, a DAS system is almost automatically synchronized as an acoustic-detection system.

Acoustic signal detected by DAS is decoded to the sensing data from other sensors, which is impossible to obtain only from fiber sensing systems such as image.

By utilizing the active acoustic signal propagating in 3D space, the sensing range is extended. Acoustic repeaters may also be employed to extend the range.

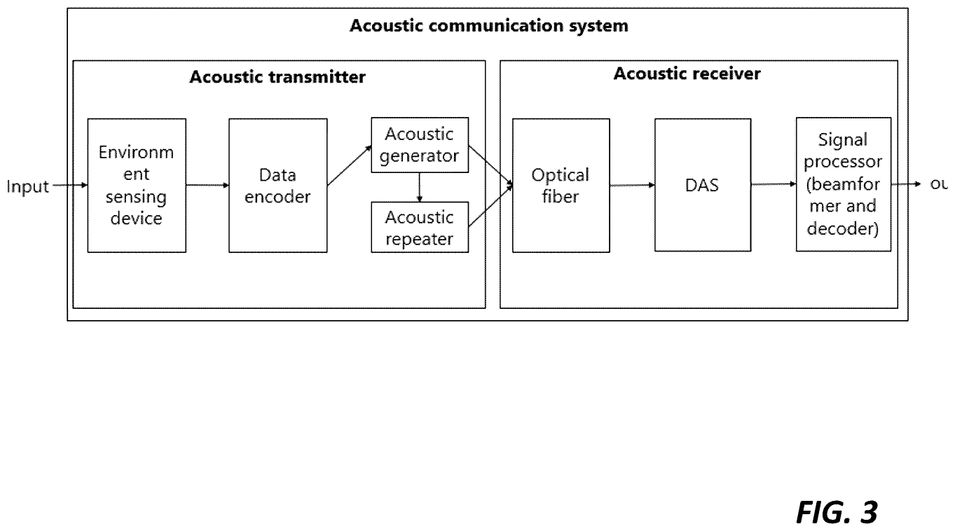

FIG. 3 is a schematic flow diagram showing illustrative operational flow and architecture of a DFOS/DAS UWSN according to aspects of the present disclosure. As illustratively shown, our inventive arrangement primarily includes two overarching components, namely a transmitter and a receiver.

Operationally, environmental data is collected by one or more sensing device(s) and transformed into an encoded signal through the effect of a data encoder. This encoded signal is then used to generate an acoustic signal by an acoustic generator and/or acoustic repeater which in turn is then transmitted via the underwater/aqueous medium. The optical sensor fiber, which is connected to the DAS system, receives the acoustic signal transmitted from either the acoustic generator or the repeater. The acoustic signal results in the backscatter phase change(s) described previously which are received by and processed by the signal processor using a beamformer and data decoder. Consequently, the sensing data originating from the transmitter is conveyed to the location where the signal processor is situated.

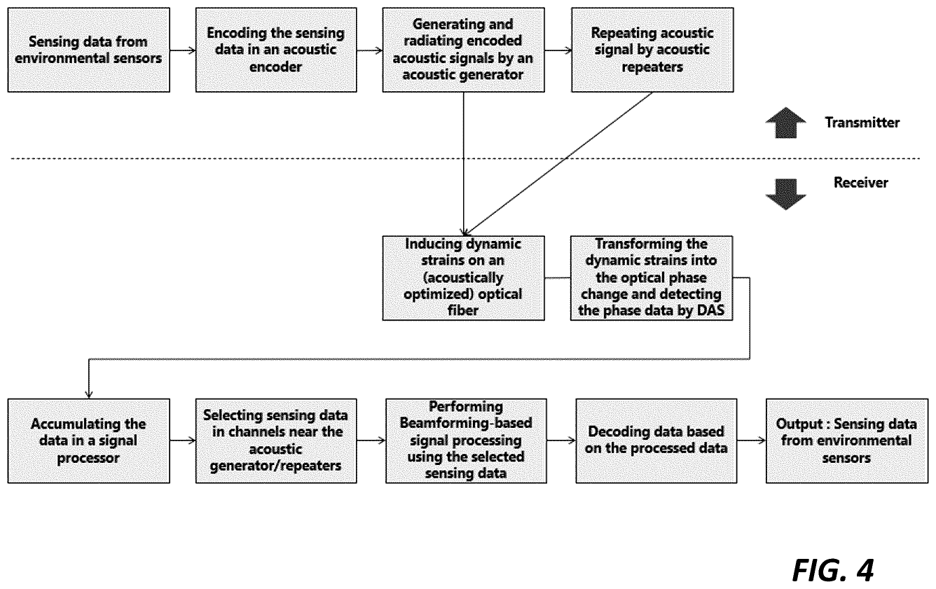

FIG. 4 is a schematic flow diagram showing an illustrative embodiment of a DFOS/DAS UWSN according to aspects of the present disclosure. One of the embodiments of this disclosure and invention involves the transmission of data as illustrated in this figure. Specifically, this embodiment describes the process of transmitting sensing data from the undersea transmitter to the on-land receiver via an optical fiber sensor cable where the DAS with a signal processor is connected to the optical fiber sensor cable.

### Transmitter

### Environmental Sensing

Acquire data through a variety of environmental sensors, including temperature, pressure, salinity, imaging, and more. The system is not restricted to single-sensor data collection and can incorporate information on sensor locations and labels. Additionally, these sensors can be integrated with mobile platforms such as AUVs for enhanced data gathering.

### Sensing Data Encoding

The sensing data is encoded by modulating a carrier signal using techniques such as Frequency Shift Keying (FSK), Phase Shift Keying (PSK), or Quadrature Amplitude Modulation (QAM). However, the choice of encoding must be appropriate and carefully selected, taking into consideration factors such as the modulation type, carrier frequency, and bandwidth (transmission rate). In the case of DAS, the bandwidth of the system is limited as the total length of the cable increases. This is because the sampling rate of the data is determined by the endpoint of the backscattered light, and as the cable length increases, the time it takes for the backscattered light to travel the length of the cable increases, limiting the overall sampling rate and therefore the bandwidth of the system.

### Acoustic-Signal Generation

The encoded signal is transmitted as an acoustic signal using an underwater speaker. To optimize the signal transmission, it is preferable that the signal path has a directional component that is aligned to the optical cable. To achieve this, using a speaker array would be more effective than a single speaker.

### Acoustic-Signal Transmission Via Acoustic Repeater

The underwater environment can be divided into several zones that can impact the transmission of acoustic signals, such as variations in temperature, pressure, and salinity. Additionally, the quality of the acoustic signal can degrade if the acoustic generator is too far from the optical cable. To mitigate these effects, acoustic repeaters can be used to amplify the signal and maintain signal quality over long distances.

### Receiver

### Acoustic-Signal Detection by DAS

Generally, DAS detects the dynamic strain on an optical fiber using a phase-sensitive Optical Time-Domain Reflectometer. The detection process involves three steps. First, an optical pulse is emitted from the interrogator and introduced into an optical sensor fiber. Rayleigh backscattered light (which occurs everywhere along the length of the optical fiber due to the fluctuation of the refractive index) propagates along the fiber back to the interrogator/analyzer. Second, the interrogator/analyzer detects phase of the backscattered light using coherent detection and calculates the phase difference between two points along the fiber whose distance is known as the gauge length. This phase difference is proportional to the local length change of the optical fiber, which in turn corresponds to the dynamic strain. Third, by repeating these first two steps at a certain frequency, a time series of data can be obtained corresponding to the dynamic strain of the fiber. Notably, because DAS can detect the phase difference between any two arbitrary points along the length of the optical sensor fiber, it can collect data at any location on the sensor fiber, enabling it to function as a distributed sensor.

To enhance the performance of acoustic detection using optical sensor fiber, acoustically optimized fibers can be utilized. One example of such fiber is optical fiber wrapped around a cylinder mandrel made of elastic materials, which improves spatial resolution and sensitivity.

### Signal Processing of DAS Data: Channel Selection

The geographical structure of underwater environments, including water depth and terrain, can significantly impact the transmission of acoustic signals. Acoustic signals generally travel longer distances in deeper water and can be more easily affected by obstacles and changes in terrain. Thus, channel selection is necessary based on the data quality to mitigate these effects. One of the simplest ways to do this is by choosing channels with high Signal-to-Noise Ratio (SNR) where the acoustic propagation process can be observed in time-space data. The selected sensing channels function as a hydrophone-array system, as they are automatically synchronized.

### Signal Processing of DAS Data: Beamforming

To optimize the quality of the transmitted signal, a beamforming algorithm is used with the selected channels. If the deployed fiber is straight, the distances between channels are known, and the channels are treated as a linear beamforming array. To improve signal quality using beamforming, the acoustic source also needs to be localized. Different types of beamformers can be chosen, e.g., adapted beamformers.

### Signal Processing of DAS Data: Demodulate and Decode

The demodulation algorithm operates based on the received beamformed signal. To appropriately demodulate the signal, the same modulation type and carrier frequency as used in the transmitter must be set. The demodulated signal is then decoded in the same format as the original sensing data.

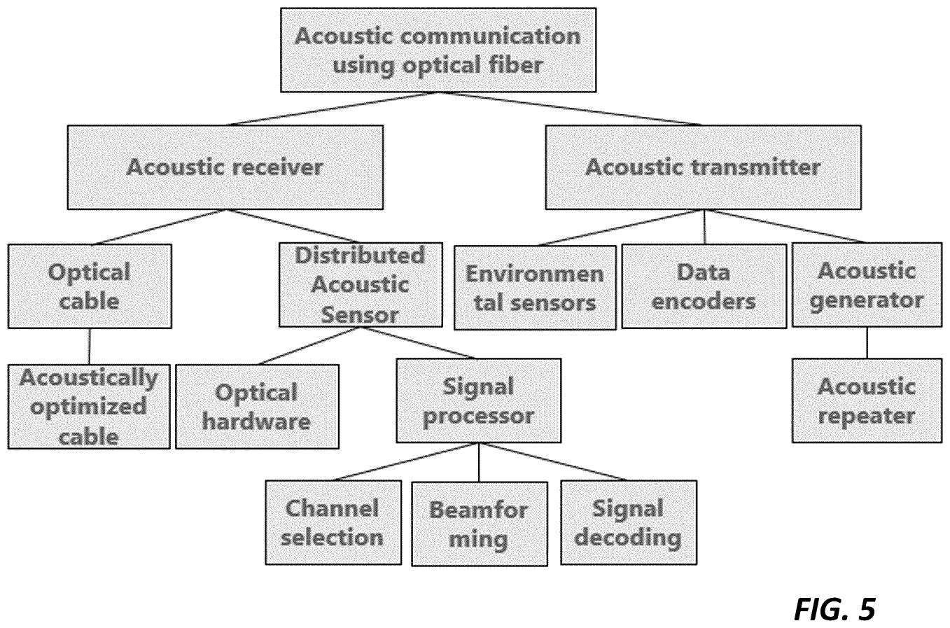

FIG. 5 is a schematic block diagram showing illustrative hierarchical relationships according to aspects of the present disclosure.

### Experimental

Recently, we have successfully utilized a DAS as a wireless acoustic receiver for fiber-optic acoustic transmission. By employing single-carrier Quadrature Phase Shift Keying (QPSK) modulation, we achieved transmission of more than 10 KB at a rate of 6.4 kbps without errors. However, we noted that multipath fading significantly influences the Bit Error Rate (BER), like the impact observed in conventional wireless communication systems. Furthermore, given the constraints of transmission bandwidth in using acoustics, a more efficient modulation scheme is necessary. To address the issues identified in our previous study, we have explored multi-carrier transmission utilizing Orthogonal Frequency Division Multiplexing (OFDM), which is recognized for its robustness against multipath fading and its high spectral efficiency.

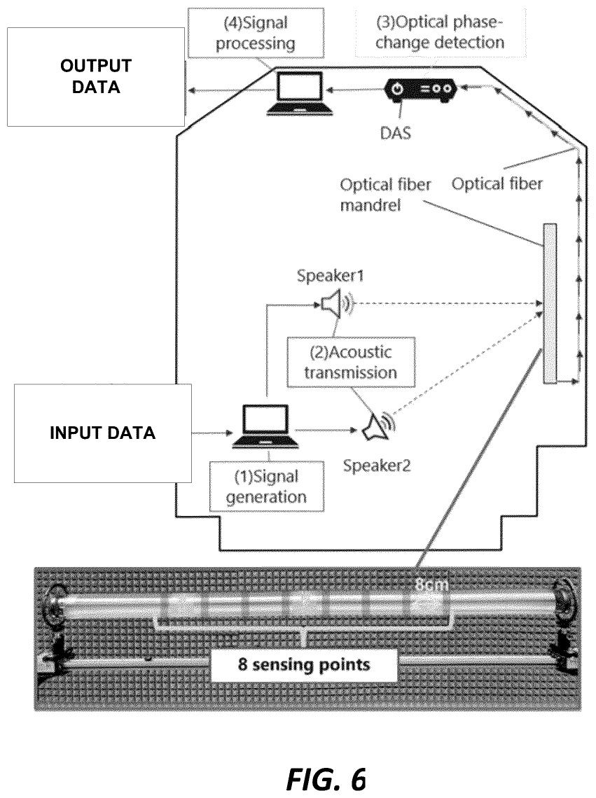

FIG. 6 is a schematic block diagram showing an illustrative experimental arrangement of a DFOS/DAS antenna array showing experimental geometry and flow of data according to aspects of the present disclosure.

As illustrated in the figure, we convert image data (JPEG, 227×71 pixels) into audio data, transmit it acoustically to an optical fiber mandrel connected to the DAS, and process the received signals. During signal generation, the image data is converted into a binary sequence, mapped onto 128 parallel subcarriers spanning 3760 to 8840 Hz, i.e., each subcarrier has a 40 Hz bandwidth.

A preamble of 20 random pilot symbols is added to each subcarrier for synchronization between the transmitter and receiver. After the inverse Fourier transformation, a raised cosine function with a roll-off factor of 0.2 is applied to the signals to suppress intercarrier interference. Zero value guard intervals of 8.4 ms are introduced between symbols to counter inter-symbol interference and suppress multipath fading, i.e., the effective bit rate is approximately 6.68 kbps.

The OFDM signal, transformed into an audio file, is emitted from speakers positioned at 90.8° or 121.4° relative to the axial line of the mandrel. The mandrel, corresponding to the acoustic receiver with eight 8 cm-spaced sensing points, comprises a 250 μm single-mode fiber wrapped around a 50.8 mm cylinder.

DAS detects phase changes in Rayleigh backscattered light between two points referring to the gauge length set 11.4 m. After receiving the phase changes at 8 sensing points, we enhance the signal quality using a beamformer steering towards the transmitting speaker and demodulate the beamforming signal. The demodulation process involves timing recovery, guard-interval removal, Fourier transformation with subcarrier gain equalization, and frequency offset correction.

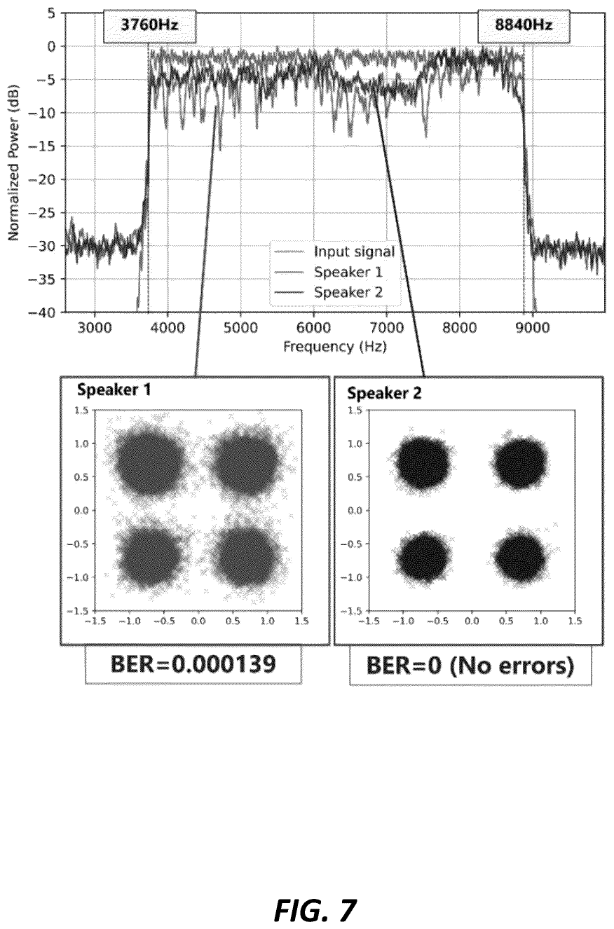

FIG. 7 is a set of plots showing normalized power spectrums of transmitted/received OFDM signals for preambles, where the maximum values are set at 0 dB, according to aspects of the present disclosure. The upper part highlights the power spectrums of the OFDM signals for preambles, smoothed using a 20-bin centered moving average, while the lower section displays the corresponding constellation diagrams. In the normalized power spectrum, the maximum power is set to 0 dB. Although the input signal is nearly flat with respect to frequency, the data received from speaker 1 or 2 exhibits frequency dependencies. Despite these dependencies the data from speaker 2 is successfully demodulated, and the input image data is reproduced without requiring any error corrections.

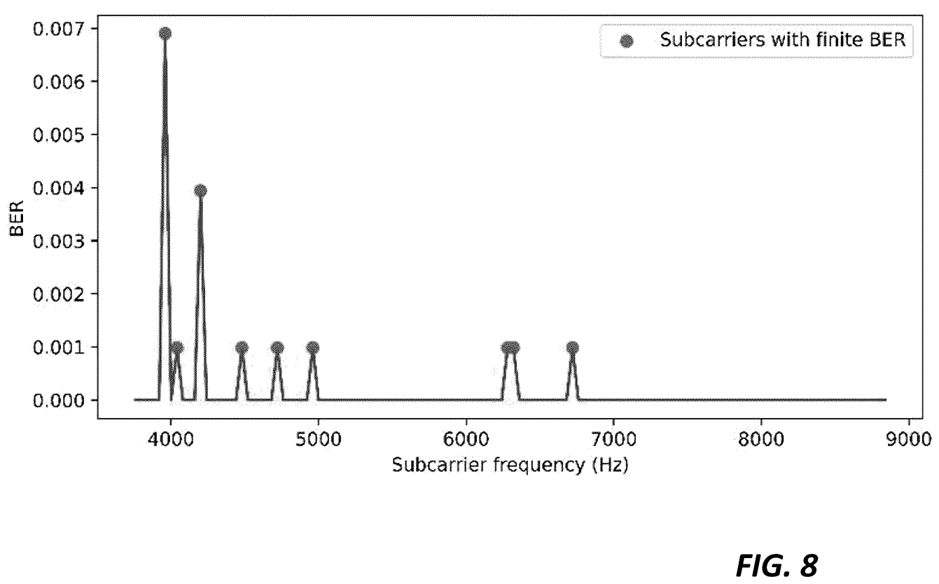

On the other hand, the signal received from speaker 1 reveals fading patterns at specific frequencies, indicating attenuations of 10 to 15 dB relative to the maximum power frequency. This fading contributes to a smearing pattern in the constellation diagram, resulting in a BER of 0.000139. Although these fading patterns do affect the quality of transmission, the multi-carrier transmission with a long symbol period significantly reduces the transmission error compared to that of single-carrier transmission. For comparison, if a single-carrier QPSK signal with a carrier frequency of 4800 Hz and a bit rate of 2.4 kbps is emitted from the same position as speaker 1, the BER increases to 0.0009 [6]. Furthermore, we can monitor the transmission quality as a function of subcarrier frequencies, as illustrated in FIG. 8, which is a plot showing bit error rate BER as a function of subcarrier frequency in which the highlighted points are subcarriers with finite BER according to aspects of the present disclosure.

In the experiment, 9 subcarriers exhibit a finite BER. Therefore, by disabling these channels it might be possible to improve the BER at the cost of data rate.

We have demonstrated the effectiveness of the acoustic data transmission using an OFDM signal to address the problems associated with data transmission using a DAS, such as multipath fading impacting the BER and limitations in the acoustic transmission bandwidth. This study offers a foundation for further exploration of optical fiber sensing technology in the context of large-scale communications, potentially leading to enhanced data transmission efficiency and quality.

1. A distributed fiber optic sensing (DFOS)/distributed acoustic sensing (DAS) acoustic antenna system comprising:
a DFOS/DAS system including:
a DFOS/DAS interrogator; and
an undersea distributed acoustic receiver in optical communication with the DFOS/DAS interrogator;
wherein the DFOS/DAS interrogator is configured to generate optical interrogator pulses, introduce the generated optical pulses into the undersea distributed acoustic receiver and receive backscattered signals from the undersea distributed acoustic receiver;
wherein the undersea distributed acoustic receiver is configured to receive acoustic signals such that the undersea distributed acoustic receiver is strained upon receipt;
wherein the strained undersea distributed acoustic receiver affects the backscattered signals.

2. The acoustic antenna system of claim 1 wherein the undersea distributed acoustic receiver comprises a length of optical sensor fiber located in an underwater location.

3. The acoustic antenna system of claim 2 further comprising one or more acoustic transmitters configured to generate the acoustic signals.

4. The acoustic antenna system of claim 3 wherein at least one of the one or more acoustic transmitters is attached to a mobile object.

5. The acoustic antenna system of claim 3 wherein at least one of the one or more acoustic transmitters is stationary.

6. The acoustic antenna system of claim 3 wherein the acoustic transmitters generate the acoustic signals in response to sensor input.

7. The acoustic antenna system of claim 3 wherein the generated acoustic signals comprise a modulated carrier signal.

8. The acoustic antenna system of claim 6 wherein the sensor input is encoded by modulating a carrier signal using a technique selected from the group consisting of: Frequency Shift Keying (FSK), Phase Shift Keying (PSK), and Quadrature Amplitude Modulation (QAM).

9. The acoustic antenna system of claim 8 including a plurality of channels, the individual ones of the plurality of channels selected based on data quality.

10. The acoustic antenna system of claim 9 wherein the generated acoustic signals are enhanced by beamforming.
